(19) United States
(12) Patent Application Publication
(10) Pub. No.: US 2016/0336769 A1
(43) Pub. Date: Nov. 17, 2016

(54) RECHARGEABLE BATTERY

(71) Applicant: Samsung SDI Co., Ltd., Yongin-si (KR)

(72) Inventors: Jaemin Kim, Yongin-si (KR); Daeyon Moon, Yongin-si (KR)

(21) Appl. No.: 14/964,368

(22) Filed: Dec. 9, 2015

(30) Foreign Application Priority Data
May 15, 2015 (KR) 10-2015-0068192

(51) Int. Cl. H02J 7/00

(52) U.S. Cl. CPC H02J 7/0026; H02J 7/0021; H02J 7/0042

(57) ABSTRACT

A rechargeable battery is disclosed. In one aspect, the rechargeable battery includes at least two battery cells and a protective circuit configured to control charging and discharging operations of the battery cells. The rechargeable battery also includes a thermistor electrically connected to the protective circuit and a spacer placed between the battery cells and accommodating at least a portion of the thermistor. According to some embodiments, the rechargeable battery can reduce an internal space within a case thereof and provide a compact structure that is advantageous for miniaturization.

### CROSS-REFERENCE TO RELATED APPLICATION

This application claims the benefit of Korean Patent Application No. 10-2015-0068192, filed on May 15, 2015, in the Korean Intellectual Property Office, the disclosure of which is incorporated herein in its entirety by reference.

### BACKGROUND

1. Field

The described technology generally relates to a rechargeable battery.

2. Description of the Related Technology

Due to the development of wireless Internet and communication technologies, portable electronic devices, such as mobile phones or portable computers, which can operate by a battery, have been widely used. In order to use electronic devices in various places regardless of a power supply device, the electronic devices may include one or more rechargeable batteries.

### SUMMARY OF CERTAIN INVENTIVE ASPECTS

One inventive aspect relates to a rechargeable battery saving limited internal space in a case thereof and having a compact structure that is advantageous for miniaturization.

Another aspect is a rechargeable battery includes at least two battery cells; a protective circuit controlling charging and discharging operations of the battery cells; a thermistor electrically connected to the protective circuit; and a spacer placed between the battery cells and providing a mounting space for the thermistor.

In one embodiment, the thermistor may be accommodated in a step space of the spacer.

In one embodiment, the step space may be open toward outside of the spacer.

In one embodiment, the step space may be open toward the protective circuit, and a lead wiring of the thermistor extends toward the protective circuit through the step space.

In one embodiment, the thermistor may be in contact with the step space and supported by side walls of the spacer defining the step space.

In one embodiment, the spacer may include a first portion and a second portion stepped to each other in a width direction, and the thermistor may be supported on the second portion having a width narrower than the first portion.

In one embodiment, the second portion may be placed closer to the protective circuit than the first portion.

In one embodiment, the thermistor may include a sensor chip converting temperature information of the battery cell into an electrical temperature signal; and a lead wiring transmitting a temperature signal of the sensor chip to the protective circuit.

In one embodiment, the sensor chip and one end of the lead wiring extending from the sensor chip may be supported on the spacer, and the other end of the lead wiring may be supported on the protective circuit.

In one embodiment, the rechargeable battery may further include a cap cover, placed on the battery cell, in which an opening for exposing an electrode of the battery cell may be formed.

In one embodiment, the opening may further include a first opening and a second opening, respectively exposing the first electrode and the second electrode of the battery cell.

In one embodiment, the rechargeable battery may further include a connection member that may be placed on the cap cover and may be electrically connected to the electrode of the battery cell.

In one embodiment, the connection member may include a first connection member and a second connection member, respectively connected to the first electrode and the second electrode of the battery cell.

In one embodiment, a temperature-sensing element may be placed between the first electrode and the first connection member, and a third opening may be formed in the cap cover to expose the temperature-sensing element.

In one embodiment, the first connection member and the second connection member may be placed to overlap each other and extend in parallel alignment with each other.

Another aspect is a rechargeable battery comprising: at least two battery cells; a protective circuit configured to control charging and discharging operations of the battery cells; a thermistor electrically connected to the protective circuit; and a spacer placed between the battery cells and accommodating at least a portion of the thermistor.

In the above rechargeable battery, the spacer has a step space, and wherein the thermistor is accommodated in the step space of the spacer. In the above rechargeable battery, the step space is open toward outside of the spacer. In the above rechargeable battery, the step space is open toward the protective circuit, and wherein a lead wiring of the thermistor extends toward the protective circuit through the step space. In the above rechargeable battery, the thermistor is in contact with the step space and supported by side walls of the spacer defining the step space.

In the above rechargeable battery, the spacer comprises a first portion and a second portion stepped to each other in a width direction, and wherein the thermistor is supported by the second portion having a width narrower than the first portion. In the above rechargeable battery, the second portion is placed closer to the protective circuit than the first portion. In the above rechargeable battery, the thermistor comprises: a sensor chip configured to convert temperature information of each of the battery cells into an electrical temperature signal; and a lead wiring configured to transmit a temperature signal of the sensor chip to the protective circuit.

In the above rechargeable battery, the sensor chip and one end of the lead wiring extending from the sensor chip are supported by the spacer, and wherein the other end of the lead wiring is supported by the protective circuit. The above rechargeable battery further comprises: a cap cover, placed on each of the battery cells, in which an opening exposing first and second electrodes of each of the battery cells is formed. In the above rechargeable battery, the opening further comprises a first opening and a second opening, respectively exposing the first electrode and the second electrodes. The above rechargeable battery further comprises: a connector placed on the cap cover and electrically connected to the electrodes.

In the above rechargeable battery, the connector comprises a first connector and a second connector, respectively connected to the first electrode and the second electrodes. The above rechargeable battery further comprises a temperature sensor placed between the first electrode and the first connection member, wherein a third opening is formed in the cap cover to expose the temperature sensor. In the above rechargeable battery, the first and second connectors overlap each other and extend in substantially parallel alignment with each other.

Another aspect is a rechargeable battery comprising: at least two battery cells; a protective circuit configured to control charging and discharging operations of the battery cells; a thermistor electrically connected to the protective circuit; and a spacer placed between the battery cells, wherein the spacer and the thermistor at least partially overlap each other in the depth dimension of the rechargeable battery.

In the above rechargeable battery, the spacer has an upper portion and a remaining portion, wherein the upper portion is closer to the protective circuit than the remaining portion, and wherein the width of the upper portion is less than the width of the remaining portion. In the above rechargeable battery, the upper portion of the spacer is configured to accommodate a portion of the thermistor such that the upper portion of the spacer and the portion of the thermistor overlap each other in the depth dimension of the rechargeable battery, wherein the remaining portion does not overlap the portion of the thermistor, and wherein the portion of the thermistor and the upper portion of the spacer are interposed between the battery cells. In the above rechargeable battery, the height of the upper portion is less than a half of the remaining portion. In the above rechargeable battery, the height of the spacer is substantially the same as the height of each of the battery cells.

### BRIEF DESCRIPTION OF THE DRAWINGS

These and/or other aspects will become apparent and more readily appreciated from the following description of the exemplary embodiments, taken in conjunction with the accompanying drawings.

FIG. 1 is a perspective view of a rechargeable battery according to an exemplary embodiment.

FIG. 2 is an exploded perspective view illustrating portions of the rechargeable battery illustrated in FIG. 1.

FIG. 3 is an exploded perspective view illustrating the portions of the rechargeable battery illustrated in FIG. 2.

FIG. 4 is a perspective view of a rechargeable battery for explaining mounting configuration of a thermistor.

FIGS. 5 and 6 are views for explaining a mounting configuration of the thermistor 190, viewed in different directions.

### DETAILED DESCRIPTION OF CERTAIN INVENTIVE EMBODIMENTS

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. In this disclosure, the term “substantially” includes the meanings of completely, almost completely or to any significant degree under some applications and in accordance with those skilled in the art. Moreover, “formed on” can also mean “formed over.” The term “connected” includes an electrical connection.

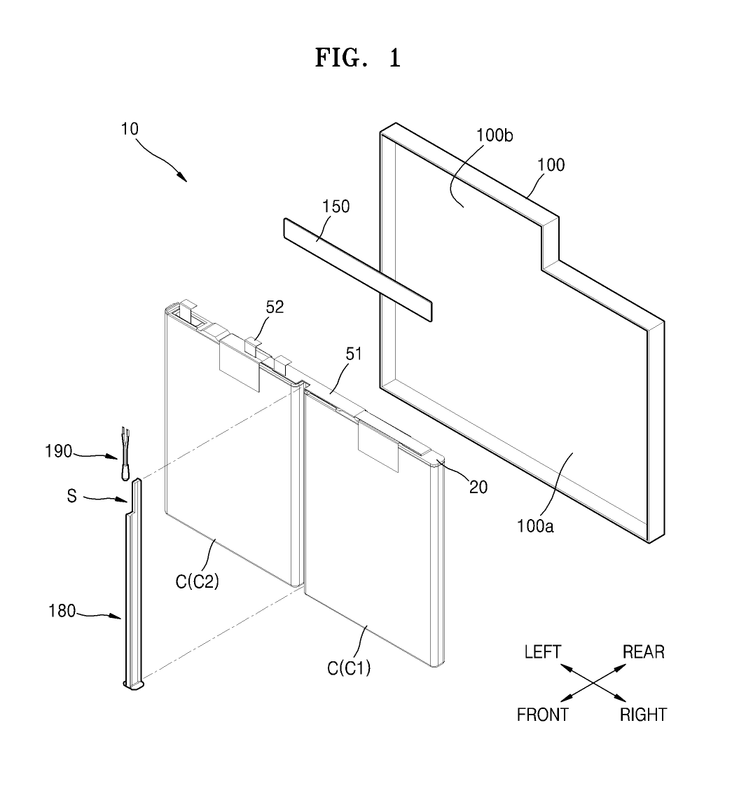

Hereinafter a rechargeable battery according to an exemplary embodiment will be described referring to drawings. FIG. 1 is a perspective view of a rechargeable battery 10 according to an exemplary embodiment.

Referring to FIG. 1, the rechargeable battery 10 includes first and second battery cells C1 and C2, connection members or connectors 51 and 52 forming a charging and discharging current path of the first and second battery cells C1 and C2, a protective circuit 150 electrically connected to the connection members 51 and 52, and a case accommodating the first and second battery cells C1 and C2 and the protective circuit 150.

In some embodiments, the first and second battery cells C1 and C2 have substantially the same structure. In the present disclosure, the term “battery cell C” may refer to one of the first and second battery cells C1 and C2. However, the following description will be presented based on the first battery cell C1 for the convenience of understanding, and the term “battery cell C” refers to the first battery cell C1 unless otherwise mentioned.

For example, an electrode of the battery cell C is an electrode of any one of the first and second battery cells C1 and C2. However, in the following description, an electrode of the battery cell C is assumed to be an electrode of the first battery cell C1 unless otherwise mentioned.

The case 100 may include a cell accommodation portion 100a accommodating the battery cell C and a circuit accommodation portion 100b accommodating the protective circuit 150. The protective circuit 150 is electrically connected to the battery cell C through the connection members 51 and 52 for controlling charging and discharging operations of the battery cell C.

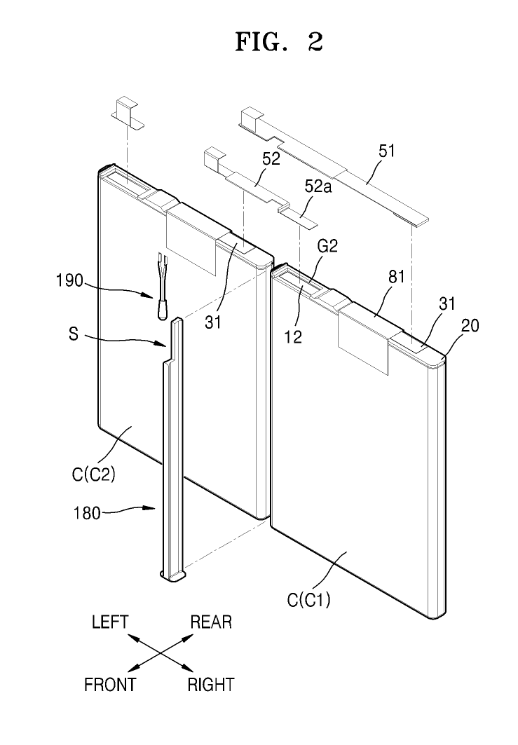

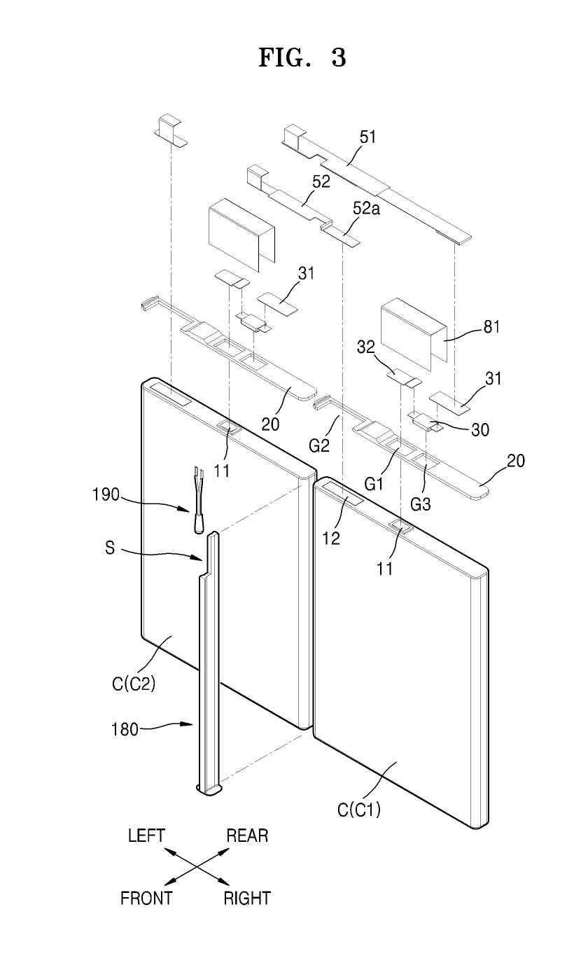

FIG. 2 is an exploded perspective view illustrating portions of the rechargeable battery illustrated in FIG. 1. FIG. 3 is an exploded perspective view illustrating the portions of the rechargeable battery illustrated in FIG. 2.

Referring to FIGS. 2 and 3, the rechargeable battery includes the battery cell C including electrodes 11 and 12, a cap cover 20 placed on the battery cell C, in which openings G1 and G2 are formed to expose the electrodes 11 and 12, and connection members 51 and 52 electrically connected to the electrodes 11 and 12.

The connection members 51 and 52 may include the first and second connection members 51 and 52 electrically connected to first and second electrodes 11 and 12 of the battery cell C, respectively. The first and second connection members 51 and 52 may connect the battery cell C to the protective circuit 150 for forming the charging and discharging current path. For example, ends of the first and second connection members 51 and 52 may be placed close to the first and second electrodes 11 and 12 of the battery cell C for direct or indirect connection with the first and second electrodes 11 and 12. The other ends of the first and second connection members 51 and 52 may be connected to the protective circuit 150. The first and second connection members 51 and 52 may overlap each other on the cap cover 20 and may extend in substantially parallel alignment with each other.

In the exemplary embodiment shown in FIG. 2, the first and second connection members 51 and 52 extend outwardly from the battery cell C. That is, the first and second connection members 51 and 52 electrically connected to the first battery cell C1 extend from the first battery cell C1 to the second battery cell C2. However, the present disclosure is not limited thereto. For example, according to the position of the protective circuit 150, the second connection member 52 may extend outwardly from the battery cell C, and the first connection member 51 may not extend outwardly from the battery cell C. That is, the extension lengths of the first and second connection members 51 and 52 may vary according to positions at which the two connection members 51 and 52 are connected to the protective circuit 150.

Referring to FIG. 2, the rechargeable battery includes the first and second battery cells C1 and C2 neighboring each other, and the first and second battery cells C1 and C2 are electrically connected to each other through the connection members 51 and 52. For example, the neighboring battery cells C are connected in series or parallel as the connection members 51 and 52 extending from one battery cell C are electrically connected to the electrodes 11 and 12 of another battery cell C.

The second connection member 52, of the first and second connection members 51 and 52 of the first battery cell C1 may extend toward the second battery cell C2 and may be electrically connected to the first electrode 11 of the second battery cell C2, for example, to a lead terminal 31 connected to the first electrode 11 of the second battery cell C2. In this case, the second connection member 52 may connect the second electrode 12 of the first battery cell C1 to the first electrode 11 of the second battery cell C2, for example, to the lead terminal 31 connected to the first electrode 11 of the second battery cell C2. That is, the second connection member 52 may connect the opposite polarity electrodes of the first and second electrodes 11 and 12 of the first and second battery cells C1 and C2 so as to connect the two battery cells C1 and C2 together in series.

Although FIG. 2 illustrates that the rechargeable battery includes two battery cells C, the present disclosure is not limited thereto. In other exemplary embodiments, for example, the rechargeable battery may include only one battery cell C or include three or more battery cells C.

Referring to FIG. 3, the first connection member 51 is electrically connected to the first electrode 11 through a temperature-sensing element or temperature sensor 30. The temperature-sensing element 30 may be placed between the first electrode 11 and the first connection member 51, forming the charging and discharging current path.

Lead terminals 31 and 32 may be placed on both ends of the temperature-sensing element 30. For example, the lead terminal 32 is electrically connected to the first electrode 11 exposed upwardly through a first opening G1. The lead terminal 31 can be connected to the first connection member 51.

A third opening G3 may be formed in the cap cover 20 to expose the temperature-sensing element 30. The temperature-sensing element 30 may be placed close to the battery cell C so as to precisely measure the temperature of the battery cell C. To this end, the third opening G3 may be formed in the cap cover 20 to expose the temperature-sensing element 30 to an exterior surface of the battery cell C.

The first and second openings G1 and G2 may be formed in the cap cover 20 to respectively expose the first and second electrodes 11 and 12. The first and second electrodes 11 and 12 exposed through the first and second openings G1 and G2 may be respectively connected to the first and second connection members 51 and 52. In addition, the third opening G3 may be formed in the cap cover 20 to expose the temperature-sensing element 30.

In order for the battery cell C and the first and second connection members 51 and 52 to be electrically connected to each other, a thermal joining process, such as welding on a plurality of positions, may be performed. For example, to electrically connect the first electrode 11 to the first connection member 51 through the temperature-sensing element 30, the lead terminal 32 placed on an end of the temperature-sensing element 30 may be welded to the first electrode 11, or the lead terminal 31 placed on the end of the temperature-sensing element 30 may be welded to the first connection member 51. In addition, the second electrode 12 and a leg portion 52a of the second connection member 52 may be connected together by a thermal joining process, such as welding.

The connection members 51 and 52 may include conductive patterns (not shown) for forming current paths and insulation coatings (not shown) for insulating the conductive patterns. In an exemplary embodiment, the connection members 51 and 52 may refer to any members electrically connected to the battery cell C to form the charging and discharging current path. For example, the term “connection members 51 and 52” may be used in a broad meaning including elements such as tabs, coverlays, plates, terminals, etc.

In FIG. 3, an insulation tape piece 81 may be used to fix the position of the temperature-sensing element 30 to the battery cell C and insulate the temperature-sensing element 30 from the connection members 51 and 52. Although not illustrated in the drawing, another insulation tape piece may be used to encase the first and second connection members 51 and 52 together to fix the positions of the first and second connection members 51 and 52 and insulate the first and second connection members 51 and 52 from the outside.

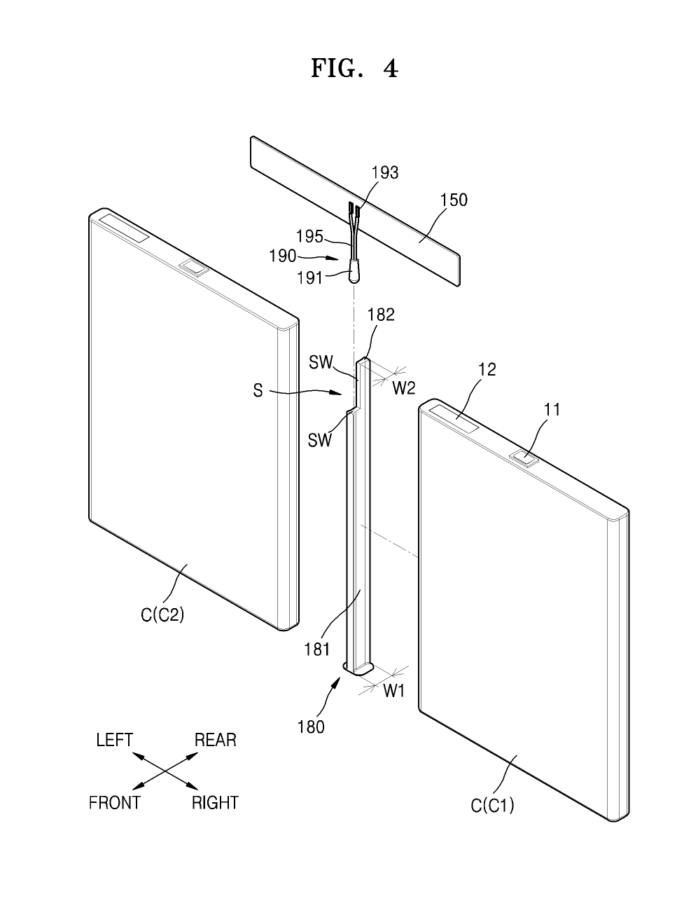

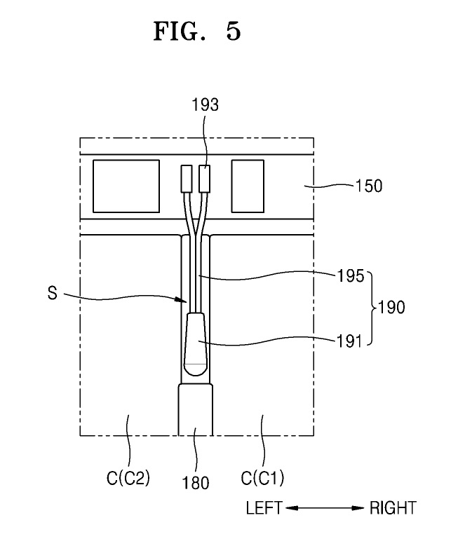

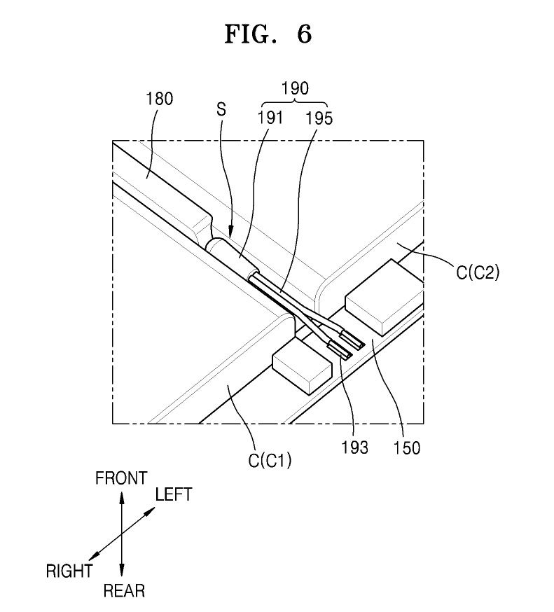

FIG. 4 is a perspective view of a rechargeable battery for explaining mounting configuration of a thermistor 190. FIGS. 5 and 6 are views in different perspectives for explaining a mounting configuration of the thermistor 190. In the drawings, the connection members 51 and 52 are omitted.

Referring to FIGS. 4 to 6, a spacer 180 is placed between the first and second battery cells C1 and C2. Although the spacer 180 is provided to keep a distance between the first and second battery cells C1 and C2, the space 180 that is placed between the first and second battery cells C1 and C2 may prevent electrical or thermal interference between the first and second battery cells C1 and C2. Surfaces of the first and second battery cells C1 and C2 may have a polarity, for example, the same polarity as the second electrodes 12 of the first and second battery cells C1 and C2. Here, the spacer 180 may be placed between the first and second battery cells C1 and C2 so as to prevent electrical short-circuit. To this end, the spacer 180 may be formed of an insulation material. In addition, the spacer 180 may prevent transfer of operation heat, which is generated due to charging and discharging operations, between the first and second battery cells C1 and C2 and a chain of thermal runaway between the first and second battery cells C1 and C2.

The spacer 180 may be formed in close contact with sides of the first and second battery cells C1 and C2. For example, the spacer 180 may include concave sides to be in close contact with round edges of the first and second battery cells C1 and C2. For example, the spacer 180 may be formed of an elastic material so that the spacer 180 may be elastically deformed to be in close contact with the first and second battery cells C1 and C2 therebetween. As such, the spacer 180 in close contact between the first and second battery cells C1 and C2 may maintain a regular position by being firmly fixed therebetween.

The spacer 180 may provide a mounting space for the thermistor 190. The thermistor 190 may convert temperature information of a measurement position into an electrical signal to transmit the electrical signal to the protective circuit 150. For example, the thermistor 190 may generate a voltage signal in response to a temperature of a measurement object. The thermistor 190 may be embodied by a resistance temperature sensor in which electrical resistance varies according to a temperature.

The thermistor 190 may be placed between first and second battery cells C1 and C2, which are measurement objects. For example, the thermistor 190 may measure an average temperature between the first and second battery cells C1 and C2. Placing one thermistor 190 between the first and second battery cells C1 and C2 allows forming a favorable structure in terms of cost, compared to placing the thermistor 190 on each of the first and second battery cells C1 and C2. However, in the present disclosure, in the case that the number of the battery cells C is two or more and the thermistor 190 is assigned to every two neighboring battery cells C, a plurality of thermistors 190, not just one thermistor 190, may be used.

The thermistor 190 may include a sensor chip 191 and a lead wiring 195 through which application of an external driving power is received and an electrical temperature signal generated from the sensor chip 191 is transmitted to the outside. For example, the thermistor 190 may receive application of driving power via an external source that is the protective circuit 150 and transmit the measured electrical signal to the protective circuit 150. The sensor chip 191 may further include an exterior member (not shown) on a surface of the sensor chip 191 for protecting internal structure thereof. For example, the exterior member in which an internal structure of the sensor chip 191 is embedded may protect the internal structure of the sensor chip 191 from external impact or foreign matters. In an exemplary embodiment, the providing of a mounting space for the thermistor 190 by the spacer 180 may mean that at least the sensor chip 191 of the thermistor 190 is supported on the spacer 180. For example, in some embodiments, the sensor chip 191 and a part of the lead wiring 195 of the thermistor 190 may be supported on the spacer 180.

The lead wiring 195 may transmit an electrical temperature signal generated by the sensor chip 191 to the protective circuit 150. The lead wiring 195 may extend from the sensor chip 191 to the protective circuit 150, and include one end connected to the sensor chip 191 and the other end connected to the protective circuit 150.

The lead wiring 195 may include a metal thin wire, and may be formed of a ductile wire. The lead wiring 195 may include one end supported on the spacer 180 and the other end supported on the protective circuit 150. The other end of the lead wiring 195 may form electrical connection with the protective circuit 150, and may be covered by an insulation tape piece 193 so as to insulate a connection portion.

The thermistor 190 may be accommodated in a step space S of the spacer 180. For example, the spacer 180 may include a first portion 181 and a second portion 182 having different width, wherein the first portion 181 may have a relatively wide width W1, and the second portion 182 may have a relatively narrow width W2. Here, the first and second portions 181 and 182 may form a step with respect to a width direction, and the thermistor 190 may be accommodated in the formed step space S.

The thermistor 190 may be supported on the second portion 182 extending from the first portion 181 with a relatively narrow width. In greater detail, the thermistor 190 may be supported by at least one portion of exposed side walls SW of the first portion 181 and second portion 182 contacting the step space S. For example, the thermistor 190 may be supported by both of the side walls SW of the first portion 181 and the second portion 182, which define a step space S while contacting the step space S.

The lead wiring 195 of the thermistor 190 may extend to the protective circuit 150 via the step space S. To this end, the step space S of the spacer 180, in which the thermistor 190 is accommodated, may be open toward the outside. For example, the step space S may be open toward the protective circuit 150, and the lead wiring 195 of the thermistor 190 may extend to the protective circuit 150 via the step space S.

In other words, the second portion 182, by which the thermistor 190 is supported, may be formed adjacent to an outer side of the spacer 180, and the step space S formed on the second portion 182 may be open toward the outside. Here, the sensor chip 191 of the thermistor 190 may be supported on the second portion 182, and the lead wiring 195 extending from the sensor chip 191 may extend to the protective circuit 150 via the step space S on the second portion 182. When it comes to relative placement of the first and second portions 181 and 182, the second portion 182 may be placed relatively close to the protective circuit 150 compared to the first portion 181.

The lead wiring 195 may extend from the sensor chip 191 supported on the spacer 180 to the protective circuit 150. At least one portion of the lead wiring 195 may be supported on the spacer 180. In greater detail, one end of the lead wiring 195 extending from the sensor chip 191 may be supported on the spacer 180, and the other end of the lead wiring 195 may be connected to the protective circuit 150 to thereby be supported on the protective circuit 150. The lead wiring 195 may be formed of two strands. One strand of the lead wiring 195 may be for application of driving power to the thermistor 190. The other strand of lead wiring 195 may be for receiving an electrical temperature signal from the thermistor 190. Here, one end of the two strands of lead wiring 195 may together be supported on the spacer 180, and the other end of the two strands of lead wiring 195 may together be supported on the protective circuit 150.

In an exemplary embodiment, the spacer 180, which insulates between neighboring battery cells C, provides a mounting space for the thermistor 190. That is, the spacer 180 electrically insulates neighboring battery cells C and provides a mounting space for the thermistor 190. In a comparative example, the spacer 180 placed between battery cells C serves as an insulator only, and the thermistor 190 is mounted at a separate position. In the comparative embodiment, wherein the spacer 180 and the thermistor 190 are mounted at separated positions, mounting spaces for each the spacer 180 and the thermistor 190 in a limited space, for example, in a limited internal space of the case 100, were required, causing an increase of a size of a rechargeable battery and waste of space. According to some embodiments, since the spacer and the thermistor are at least partially overlappingly mounted in a space, space may be saved and a compact structure that is advantageous for miniaturization may be available.

In an exemplary embodiment, the spacer 180 placed between neighboring battery cells C may provide a mounting space for the thermistor 190. For example, the spacer 180 may serve as a physical separation and electrical isolation between neighboring battery cells C, as well as a mounting space for the thermistor 190. As such, the spacer 180 and the thermistor 190 are mounted in an overlapping space, thereby achieving space saving and having a compact structure that is advantageous for miniaturization.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While the inventive technology has been described with reference to the figures, it will be understood by those of ordinary skill in the art that various changes in form and details may be made therein without departing from the spirit and scope as defined by the following claims.

What is claimed is:

1. A rechargeable battery comprising:
at least two battery cells;
a protective circuit configured to control charging and discharging operations of the battery cells;
a thermistor electrically connected to the protective circuit; and
a spacer placed between the battery cells and accommodating at least a portion of the thermistor.

2. The rechargeable battery of claim 1, wherein the spacer has a step space, and wherein the thermistor is accommodated in the step space of the spacer.

3. The rechargeable battery of claim 2, wherein the step space is open toward outside of the spacer.

4. The rechargeable battery of claim 3, wherein the step space is open toward the protective circuit, and wherein a lead wiring of the thermistor extends toward the protective circuit through the step space.

5. The rechargeable battery of claim 2, wherein the thermistor is in contact with the step space and supported by side walls of the spacer defining the step space.

6. The rechargeable battery of claim 5, wherein the spacer comprises a first portion and a second portion stepped to each other in a width direction, and wherein the thermistor is supported by the second portion having a width narrower than the first portion.

7. The rechargeable battery of claim 6, wherein the second portion is placed closer to the protective circuit than the first portion.

8. The rechargeable battery of claim 1, wherein the thermistor comprises:
a sensor chip configured to convert temperature information of each of the battery cells into an electrical temperature signal; and
a lead wiring configured to transmit a temperature signal of the sensor chip to the protective circuit.

9. The rechargeable battery of claim 8, wherein the sensor chip and one end of the lead wiring extending from the sensor chip are supported by the spacer, and wherein the other end of the lead wiring is supported by the protective circuit.

10. The rechargeable battery of claim 1, further comprising: a cap cover, placed on each of the battery cells, in which an opening exposing first and second electrodes of each of the battery cells is formed.

11. The rechargeable battery of claim 10, wherein the opening further comprises a first opening and a second opening, respectively exposing the first electrode and the second electrodes.

12. The rechargeable battery of claim 10, further comprising: a connector placed on the cap cover and electrically connected to the electrodes.

13. The rechargeable battery of claim 12, wherein the connector comprises a first connector and a second connector, respectively connected to the first electrode and the second electrodes.

14. The rechargeable battery of claim 13, further comprising a temperature sensor placed between the first electrode and the first connection member, wherein a third opening is formed in the cap cover to expose the temperature sensor.

15. The rechargeable battery of claim 13, wherein the first and second connectors overlap each other and extend in substantially parallel alignment with each other.

16. A rechargeable battery comprising:
at least two battery cells;
a protective circuit configured to control charging and discharging operations of the battery cells;
a thermistor electrically connected to the protective circuit; and
a spacer placed between the battery cells, wherein the spacer and the thermistor at least partially overlap each other in the depth dimension of the rechargeable battery.

17. The rechargeable battery of claim 16, wherein the spacer has an upper portion and a remaining portion, wherein the upper portion is closer to the protective circuit than the remaining portion, and wherein the width of the upper portion is less than the width of the remaining portion.

18. The rechargeable battery of claim 17, wherein the upper portion of the spacer is configured to accommodate a portion of the thermistor such that the upper portion of the spacer and the portion of the thermistor overlap each other in the depth dimension of the rechargeable battery, wherein the remaining portion does not overlap the portion of the thermistor, and wherein the portion of the thermistor and the upper portion of the spacer are interposed between the battery cells.

19. The rechargeable battery of claim 17, wherein the height of the upper portion is less than a half of the remaining portion.

20. The rechargeable battery of claim 16, wherein the height of the spacer is substantially the same as the height of each of the battery cells.
